(19) United States
(12) Patent Application Publication
(10) Pub. No.: US 2004/0085448 A1
(43) Pub. Date: May 6, 2004

(54) Vehicle occupant detection apparatus for deriving information concerning condition of occupant of vehicle seat

(76) Inventors: Tomoyuki Goto, Anjo-shi (JP); Hironori Sato, Nishio-shi (JP); Hisanaga Matsuoka, Okazaki-shi (JP); Yukihiro Saito, Chiryu-shi (JP)

Correspondence Address: POSZ & BETHARDS, PLC, 11250 ROGER BACON DRIVE, SUITE 10, RESTON, VA, 20190, US

(21) Appl. No.: 10/689,061

(22) Filed: Oct. 21, 2003

(30) Foreign Application Priority Data
Oct. 22, 2002 (JP) 2002-307030

(51) Int. Cl. H04N 7/18

(52) U.S. Cl. 348/148; 348/152; 340/425.5; 701/45

(57) ABSTRACT

A vehicle occupant detection system for acquiring digital images of a region containing a vehicle seat and applying processing of the images to detect the occupant status of the seat, wherein the images are photographed by infra-red light using a camera and infra-red light projection apparatus each located above and ahead of the seat location, whereby the images are unaffected by sunlight, vehicle headlights, or street lights, etc., enabling accurate status detection results to be acquired.

### BACKGROUND OF THE INVENTION

1. Field of Application

The present invention relates to a vehicle occupant detection system for detecting the condition of an occupant of a seat in a vehicle.

2. Description of Prior Art

In the prior art, a type of vehicle occupant protection system has been proposed whereby a CCD (charge-coupled device) digital camera is attached at a location such as in a map lamp on the ceiling of a vehicle interior, for capturing digital images of the vehicle interior by use of natural light. The digital data expressing an image captured by the camera is processed using a template to extract a circular region of the image, and the extracted results are used to detect the position of the head of a vehicle occupant. Such a system is proposed for example in Japanese Patent No. 2001-331790.

However with such a prior art type of vehicle occupant detection system, the operation is affected by changes in the ambient illumination of the vehicle, so that it is difficult to capture images that have a stable level of brightness. For example in the morning or evening, when sunlight may fall obliquely into the vehicle interior, the brightness of the captured image may be excessively high, and the image may become completely white. On the other hand, when the vehicle is operated at night, the illumination in the vehicle interior may become insufficient. In an attempt to overcome these problems, the lens aperture of the camera may be made large during night operation, and in addition auxiliary light may be projected into the vehicle interior from an auxiliary illumination apparatus, whereas during daytime operation the auxiliary light would not be emitted and the lens aperture of the control apparatus would be made small.

However if such an arrangement is used, then when the vehicle interior is illuminated by the headlamps of other vehicles while driving at night, whereas the auxiliary light is necessary up to the instant at which light from the headlamps of another vehicle enters the vehicle interior, it becomes necessary to immediately reduce the lens aperture of the camera when that external light enters the vehicle interior. Similarly in the morning or evening, when sunlight falls obliquely into the vehicle interior, it is again necessary for the camera lens aperture to be immediately reduced. In practice, it is extremely difficult to achieve such rapid changes in the camera lens aperture in response to changes in light levels within the vehicle interior, or to rapidly switch the auxiliary light on and off in response to such changes. Hence, it has been difficult to obtain images that have a stable level of brightness.

### SUMMARY OF THE INVENTION

It is an objective of the present invention to overcome the problems of the prior art set out above, by providing a vehicle occupant detection system which will be unaffected by changes in the ambient illumination of the vehicle, and whereby images having a stable level of brightness can be obtained, thereby enabling the condition of an occupant of a vehicle seat (i.e., whether the seat is actually occupied, whether an occupant is an adult or child, etc.) to be accurately judged by an image processing apparatus.

To achieve the above objectives, according to a first aspect, the invention provides a vehicle occupant detection system comprising an auxiliary light projection apparatus for projecting auxiliary light which is within a predetermined range of wavelengths into a predetermined region of a vehicle interior, with the predetermined region including a vehicle seat, a camera apparatus for photographing a digial image of the predetermined region, with light that is within at least a part of the range of visible wavelengths being excluded when photographing the image, and an image processing apparatus for processing the digital data expressing the image to thereby detect a condition of an occupant of the vehicle seat.

As a result, due to the fact that light at wavelengths that are within at least a part of the visible part of the spectrum is excluded when capturing the image, the image can be photographed without being significantly affected by extraneous light entering the vehicle interior, such as sunlight, light from the headlamps of other vehicles, street lamps, etc. Thus, the images obtained have a high degree of stability of brightness, and so can be processed to obtain information concerning the condition of an occupant of a vehicle seat with a high degree of accuracy.

Preferably, the aforementioned predetermined range of wavelengths of the auxiliary light includes at least a part of the near infra-red range, and the camera apparatus comprises a digital camera having a spectral sensitivity which extends to that part of the near infra-red range. In addition, an optical filter is positioned in the path of incident light which enters the digital camera, such as to pass light that is within at least a part of the near infra-red range and to block light that is within a part of the range of visible wavelengths.

In that way, the camera captures an image by means of light that is within the near infra-red range. Due to that fact, and due to the incorporation of the optical filter for preventing at least a part of the light within the visible range of wavelengths from entering the camera, the effects of extraneous light such as sunlight, headlamps etc., can be substantially entirely prevented from affecting the obtained image, since the image is obtained from near infra-red light which is reflected from the aforementioned predetermined region within the vehicle interior and is passed by the optical filter.

According to another aspect, the auxiliary light projection apparatus projects the auxiliary light irrespective of the level of brightness within the vehicle interior. As a result, the condition of the vehicle occupant can be accurately detected, irrespective of whether it is night or day. Furthermore when the vehicle enters a tunnel, and then exits from the tunnel, since the auxiliary light is projected continuously, the condition of the vehicle occupant can continue to be accurately detected, irrespective of the sudden changes in brightness of the ambient light.

According to a further aspect, the output level of the auxiliary light from the auxiliary light projection apparatus is set such that the image photographed by the camera apparatus is not affected by reflections of the auxiliary light from glass surfaces of the vehicle interior, including surfaces of a windshield and side windows of the vehicle.

As a result of appropriately setting the level of the auxiliary light in that way, it becomes possible to prevent the obtained image from being affected by reflections of the auxiliary light from glass surfaces of the vehicle interior, such as from the side windows or windshield, and also to ensure that external scenery will not be captured in the obtained image due to light passing from the exterior through the side windows, etc. Errors in detecting the condition of the vehicle occupant can thereby be prevented.

According to a further aspect, the auxiliary light projection apparatus is formed of a plurality of light sources, which project auxiliary light into respectively different regions of the vehicle interior, with these light sources being successively activated in respective light emission intervals during an exposure interval of the camera apparatus.

It can thereby be ensured that auxiliary light is projected throughout the entirety of a predetermined region in the vehicle interior, and due to the fact that the plurality of light sources are successively activated to emit light during each exposure interval, the amount of power consumed by the auxiliary light projection apparatus can be minimized, and the operating life of the light sources can be extended, by comparison with a system in which all of the light sources emit light simultaneously.

According to another aspect, the camera apparatus is preferably mounted at a front part of a ceiling of the vehicle interior, in a location which is substantially midway between the left and right sides of the vehicle interior. In that way, the aforementioned predetermined region which is captured as an image can readily be selected to be either a region in which the vehicle driver is located or a region in which the front passenger is located, and in addition it can readily be ensured that any other vehicle occupant will be outside the region which is captured as an image. Complication of image processing, such as image processing to discriminate between the heads of vehicle occupants, can thereby be avoided. Moreover with such a location of the camera apparatus, the head of a vehicle occupant (i.e., the portion of the body which it is most important to recognize) can be readily detected by processing the obtained image, even if the occupant has opened a newspaper or magazine, etc.

According to another aspect, the auxiliary light projection apparatus also is preferably disposed at a front part of the ceiling of the vehicle interior, substantially midway between the left and right sides. As a result of selecting such a location, it becomes possible to readily project the auxiliary light such as to effectively illuminate a region containing the driver or a region which contains the front passenger.

According to a further aspect, the image processing apparatus is adapted to detect the position and size of the head of the occupant of the vehicle seat which is located in the aforementioned predetermined region of the vehicle interior. With that information, it becomes possible to judge the type of occupant (i.e., adult, child, etc.) and the posture of the occupant, etc.

In addition, with a system whereby such image processing is performed to detect the position of an occupant's head, the predetermined region within the vehicle interior preferably includes a region which is close to an exit aperture of an air bag, i.e., out of which the air bag will be deployed in the event of a collision. In that case, information concerning the position of the occupant's head can be transmitted to an air bag control apparatus, for use in controlling deployment of the air bag. In that way, vehicle safety can be enhanced, since control can be applied to prevent deployment of the air bag when it is detected that the vehicle occupant's head is close to the exit aperture of the air bag, thereby preventing injury to the occupant as a result of the air bag deployment.

### BRIEF DESCRIPTION OF THE DRAWINGS

FIG. 1 is a general system block diagram of a first embodiment,

FIG. 2A is an oblique view showing a region in which a camera apparatus is installed in a vehicle interior, and

FIG. 2B is a view taken along the direction of an arrow A in FIG. 2B,

FIG. 3 is an exploded view of the camera apparatus,

FIG. 4 is a conceptual plan view of a region containing a front passenger seat, showing a region which is illuminated by light projected from an infra-red light projection apparatus, with the first embodiment,

FIG. 5 is a timing diagram showing the relationship between concurrent emission intervals of each of a set of infra-red LEDs of the infra-red light projection apparatus and exposure intervals of a digital camera of the camera apparatus, with the first embodiment,

FIG. 6 shows graphs of spectral characteristics, for describing how adverse effects of extraneous sunlight on an obtained image are reduced, with the first embodiment,

FIG. 7 shows graphs of spectral characteristics, for describing how adverse effects of extraneous light from vehicle headlamps and street lights on an obtained image are reduced, with the first embodiment,

FIG. 8 is a conceptual plan view of a region containing a front passenger seat, showing a region which is illuminated by light projected from an infra-red light projection apparatus, with a second embodiment,

FIG. 9 is a timing diagram showing the relationship between successive emission intervals of respective ones of a set of infra-red LEDs of the infra-red light projection apparatus and exposure intervals of a digital camera of the camera apparatus, with the second embodiment,

FIG. 10 shows an expanded view of a portion of the diagram of FIG. 9,

FIG. 11 shows graphs of spectral characteristics, for describing how adverse effects of extraneous sunlight on an obtained image are reduced, with the second embodiment, and

FIG. 12 shows graphs of spectral characteristics, for describing how adverse effects of extraneous light from vehicle headlamps and street lights on an obtained image are reduced, with the second embodiment.

### DESCRIPTION OF PREFERRED EMBODIMENT

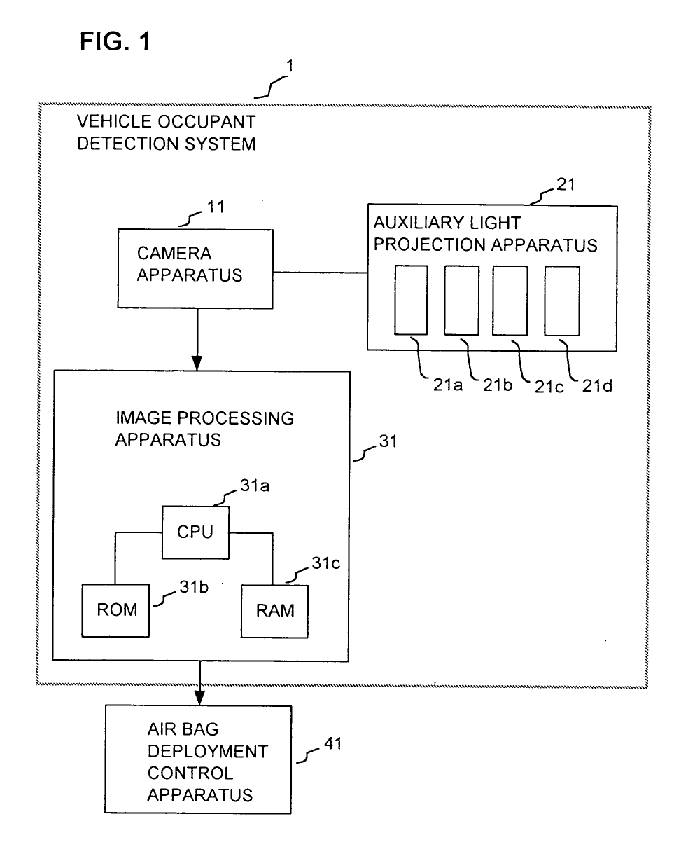

FIG. 1 is a general system block diagram showing an embodiment of a vehicle occupant detection system 1. This includes a camera apparatus 11 which photographs images of a predetermined region in a vehicle interior, i.e., with each image expressed as digital data. The vehicle occupant detection system 1 also includes a auxiliary light projection apparatus 21 which projects light that is in the near infra-red range, for thereby illuminating the predetermined region to enable the photography performed by the camera apparatus 11, and an image processing apparatus 31 which performs image processing of each image captured by the camera apparatus 11, for thereby obtaining data concerning the condition of a vehicle occupant who is located in the predetermined region of the vehicle interior, and for transmitting the data to an air bag deployment control apparatus 41.

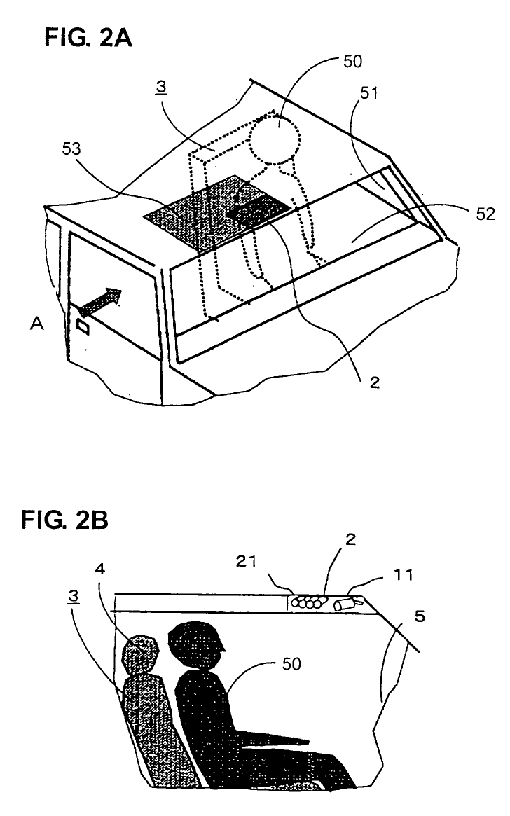

FIG. 2A is an oblique view illustrating the location in which the camera apparatus 11 is installed in the vehicle interior, and FIG. 2B is a view taken along the direction of the arrow A in FIG. 2A. As shown, the camera apparatus 11 is located in a camera installation region S at a front part of the ceiling of said vehicle interior, approximately midway between the left and right sides of the vehicle interior, with the region S extending from a position close to the map lamp 2 to a position above the driver's seat. The orientation of the camera apparatus 11 is adjusted such that the infra-red image that is obtained covers a region containing the front passenger seat 3 and extending from the head rest 4 of that seat 3 to an air bag exit aperture 5 that is located opposite the front passenger seat 3. It should be noted that the term “air bag exit aperture” is used herein to signify the outer periphery of a region from which the air bag is projected into the vehicle interior, when it is deployed.

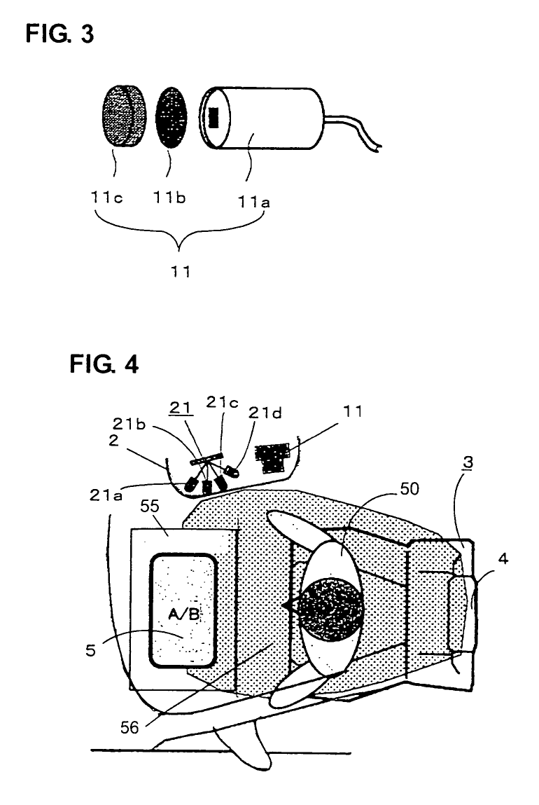

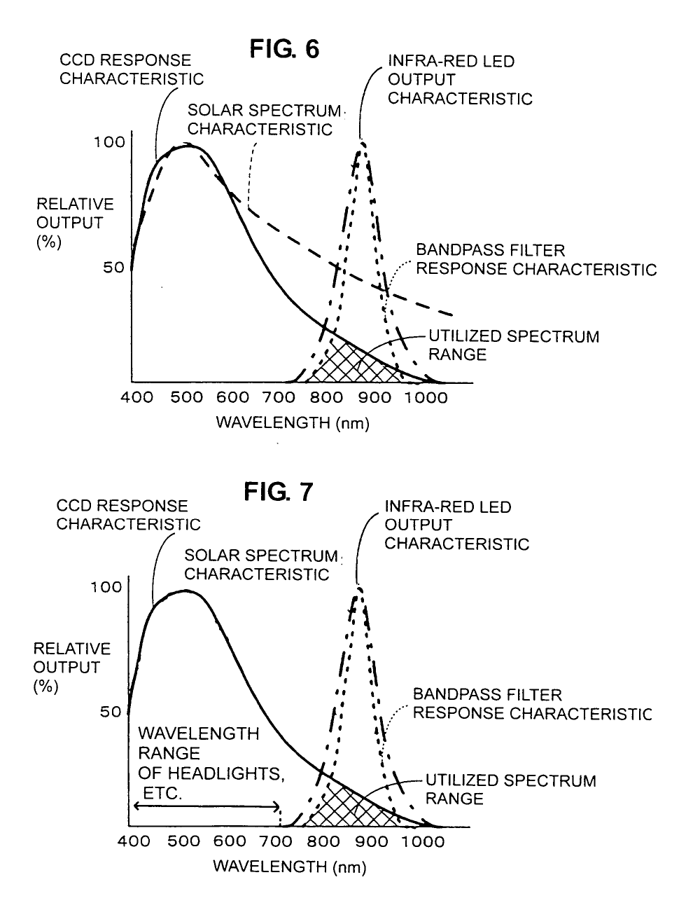

As shown in the oblique exploded view of FIG. 3, the camera apparatus 11 is made up of a digital camera 11a, an optical bandpass filter 11b and a lens 11c. The digital camera 11a utilizes a CCD (charge coupled device) type of image sensor having spectral sensitivity in a near infra-red range of wavelengths extending from 700 nm to 1000 nm. The spectral sensitivity of the CCD sensor will be further discussed hereinafter referring to the graphs of FIGS. 6 and 7.

The optical bandpass filter 11b is located in front of the CCD sensor of the digital camera 11a, i.e., in the path of light which becomes incident on that image sensor, and is configured to pass only light which is within a near infra-red range that is substantially identical to the range of wavelengths of the near infra-red light that is projected by the auxiliary light projection apparatus 21, and to cut off light at other wavelengths. The passband characteristics of the optical bandpass filter 11b are further discussed hereinafter referring to the graphs of FIGS. 6 and 7.

The lens 11c is positioned in front of the optical filter 11b, for forming on the CCD sensor of the digital camera 11a an image which is being photographed.

The auxiliary light projection apparatus 21 is mounted close to the camera apparatus 11, i.e., within the camera installation region S, above the driver's seat, adjacent to the map lamp 2. The auxiliary light projection apparatus 21 is formed of four LEDs (light emitting diodes) 21a, 21b, 21c, 21d constituting four light sources, which emit light in the near infra-red range of 700 nm to 1000 nm. With this embodiment, the four LEDs 21a˜21d emit light simultaneously. As shown in FIG. 4, this infra-red light is projected into an illuminated region R which extends from the head rest 4 of the front passenger seat 3 to the air bag exit aperture 5.

The position relationships of the camera apparatus 11 and the auxiliary light projection apparatus 21 to the region which is to be captured in an image, illustrated in FIG. 4 in conjunction with FIGS. 2A and 2B, are of basic importance to the present invention. Specifically, as shown in these drawings, the camera apparatus 11 and the auxiliary light projection apparatus 21 are each located above and ahead of the vehicle seat concerned (in this example, the front passenger seat 3) at a position which is intermediate (i.e., with respect to a longitudinal direction of the vehicle) between the the head rest 4 of the seat 3 and the air bag exit aperture 5. As a result, there is a substantially proportional relationship between distances along the longitudinal direction of the vehicle, as seen in an image obtained by the camera apparatus 11 and the corresponding actual distances within the region of the vehicle interior that is captured in the image. This fact enables the image processing apparatus 31 to apply processing to the image data for deriving the distance between the head of the seat occupant and the air bag exit aperture 5, i.e., the distance between the head of the occupant and a danger region (in the event of air bag deployment).

As shown in FIG. 1, the image processing apparatus 31 includes a CPU 31a which performs various types of processing, a ROM 31b having stored therein an image processing program, data expressing circular templates, etc., and a RAM 31c which is used as a work area. The CPU 31a receives the data expressing each image captured by the camera apparatus 11, transmitted via a communication line, and processes the image data to obtain detection results which are indicative of the condition (including presence or absence) of the occupant of the front passenger seat. The image processing apparatus 31 then transmits these detection results to the air bag deployment control apparatus 41 via a communication line.

The air bag deployment control apparatus 41 controls deployment of the air bag whose exit aperture 5 is located before the front passenger seat, with control being performed in accordance with the detection results supplied from the image processing apparatus 31. Specifically, based on the detection results, the air bag deployment control apparatus 41 implements one of a plurality of different modes of control (in the event of a vehicle collision), i.e., enabling or inhibiting deployment of the air bag, and (when deployment is enabled) limiting the degree of deployment or producing full deployment, etc.

The operation will be described in more detail in the following. With the auxiliary light projection apparatus 21 projecting infra-red light as auxiliary light into the illuminated region R, the camera apparatus 11 captures an infra-red image of the aforementioned region which extends from the head rest 4 of the front passenger seat 3 to the air bag exit aperture 5. The auxiliary light projection apparatus 21 emits the infra-red light in synchronism with the operation of the camera apparatus 11 as described in the following, with the level of emitted light being constant, irrespective of the ambient illumination of the vehicle, i.e., irrespective of whether the vehicle is being driven during daytime or at night.

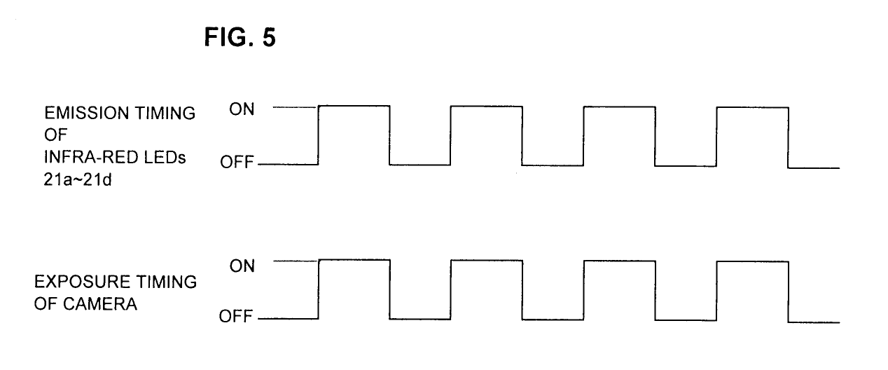

Each of the four LEDs 21a˜21d emits infra-red light only during each of successive exposure intervals of the digital camera 11a, i.e., in which respective successive images are captured by the camera 11a. This is illustrated in the timing diagram of FIG. 5. That is to say, during each of the exposure intervals (indicated as “on” intervals in FIG. 5) of the digital camera 11a, all of the four LEDs 21a˜21d concurrently project infra-red light into the illuminated region R. The level of the infra-red light emitted from the four LEDs 21a˜21d is predetermined to be sufficient for enabling an image to be obtained of the aforementioned region which extends from the head rest 4 of the front passenger seat 3 to the air bag exit aperture 5, while being low enough to ensure that no significant amount of infra-red light which has reflected from the front windshield or side windows of the vehicle will reach the lens of the digital camera 11a. It can thereby be ensured that each image obtained by the camera apparatus 11 will not be affected by such reflected infra-red light, or by light from scenery outside the vehicle. Errors in detection by the image processing apparatus 31, due to extraneous images being captured by the camera apparatus 11, can thereby be prevented.

Reflected infra-red light rays which are reflected from the area of the front passenger seat within the illuminated region R, including light rays which are reflected from the front passenger, as well as light from the exterior, are directed into the digital camera 11a by the lens 11c, through the optical bandpass filter 11b which passes only light in the near infra-red range from 7 nm to 1000 nm, to become incident on the CCD sensor of the digital camera 11a, with an infra-red image thereby being captured by the camera. Since any light rays which are outside the range from 7 nm to 1000 nm are cut, such light will have no effect upon the image obtained by the digital camera 11a.

FIG. 6 shows graphs for describing how the effects of extraneous light such as sunlight is reduced. These graphs respectively show the response characteristic of the CCD sensor of the digital camera 11a, the transmission characteristic of the optical bandpass filter 11b, the emission characteristic of a LED of the auxiliary light projection apparatus 21, and the spectral distribution of sunlight. As shown, the digital camera 11a has a spectral sensitivity which extends from the visible range to the near infra-red range (700 nm to 1000 nm) of wavelengths. In addition, the optical bandpass filter 11b passes only light that is within the infra-red range and cuts off light of other wavelengths. Moreover the light produced from the LEDs of the auxiliary light projection apparatus 21 is only within the near infra-red range. The range of wavelengths which are utilized with this embodiment is obtained by mutually superimposing the above characteristics, i.e., is the near infra-red range (700 nm to 1000 nm). Furthermore as can be understood from FIG. 6, the spectral distribution of sunlight attains large values in the visible light range, below 700 nm, and has relatively small values at wavelengths in the near infra-red range. Hence, the wavelengths of sunlight that are within the visible range are cut by the optical bandpass filter 11b, so that the aforementioned problem of the prior art, whereby an image that is captured by the camera becomes completely white as a result of the effects of obliquely incident sunlight (e.g., occurring during driving in the morning or evening) is effectively eliminated. In addition, adverse effects on the image due to excessive levels of light within the vehicle interior when driving in daytime during the summer can also be prevented.

FIG. 7 shows graphs for describing how the effects of extraneous light due to the headlamps of other vehicles or street lights, when driving at night, is reduced. These graphs respectively show the response characteristic of the CCD sensor of the digital camera 11a, the transmission characteristic of the optical bandpass filter 11b, the emission characteristic of a LED of the auxiliary light projection apparatus 21, and the spectral distribution of light emitted from vehicle headlamps and from street lights. As shown in FIG. 7, the light emitted from vehicle headlamps and from street lights is in the visible range of wavelengths, from 400 nm to 700 nm. Hence such light is substantially entirely excluded from entering the digital camera 11a by the optical bandpass filter 11b, thereby preventing adverse effects upon an image captured by the digital camera 11a as a result of such light. As examples of such adverse effects, for example a part of the head of a vehicle occupant may be excessively emphasized in the obtained image, or a print pattern on clothing of the occupant may be excessively prominent in the image, etc.

It can thus be understood that with this embodiment, satisfactory images can be obtained by the digital camera 11a of a vehicle under various conditions of ambient illumination of the vehicle, without requiring the aperture of the digital camera 11a to be adjusted or changes in the level of auxiliary light. This is true even under extreme conditions of incident light entering the vehicle, and when there are very rapid variations in the level of such incident light, such as obliquely incident sunlight when the vehicle is driven in the morning or evening, or when the vehicle interior is illuminated by the headlamps of other vehicles or by street lights, when driving at night, or when the vehicle enters and exits from a tunnel.

Data expressing each image obtained by the digital camera 11a are transmitted to the image processing apparatus 31, which applies image processing to obtain information concerning the condition of an occupant of the vehicle seat which appears in the image, i.e., with that occupant being assumed to be the front passenger, in the above description of the first embodiment. Specifically, the CPU 31a reads out an image processing program from the ROM 31b and executes that program. The image processing consists of operations such as edge detection, bi-level conversion, etc., applied to the data expressing an infra-red image which are supplied from the camera apparatus 11. Pattern matching is performed with respect to a circular template, to attempt to extract an image region corresponding to the head of the front passenger. If such a head region can in fact be extracted, then this is judged as indicating that there is actually an occupant in the front passenger seat, while if such a head region cannot be extracted then this is taken to indicate that there is no occupant of that seat. If a head region can be extracted, and that region does not attain a predetermined size, then it is judged that the front passenger is a child, while otherwise it is judged that the front passenger is an adult. If a head region can be extracted, and it is within a danger region of the vehicle interior (i.e., close to the exit aperture of the front passenger air bag) then this is judged to indicate that the front passenger is in a posture of leaning forward, with his or her head disposed close to that air bag exit aperture, while otherwise, it is judged that this occupant is seated in a normal attitude.

The vehicle occupant condition detection results which are thereby obtained are transmitted via a communication line, as digital code, to the air bag deployment control apparatus 41.

Based on the information thus received as digital code, the air bag deployment control apparatus 41 determines one of a plurality of different modes of control that will be applied when deploying the front passenger air bag (i.e., in the event of a collision). For example, if the detection results indicate that there is no occupant of the front passenger seat, then deployment of the front passenger air bag is inhibited. If the detection results indicate that the head of the front passenger is within the aforementioned danger region, then again, deployment of the front passenger air bag is inhibited. It is thereby ensured that a violent impact of the air bag against the head of the front passenger will not occur, so that the danger of injury to that occupant by the air bag is reduced. If the detection results indicate that the front passenger is a child, then control is applied such that the front passenger air bag will be only weakly deployed, i.e., to less than the maximum extent. In the case of any other detection result, the air bag will be fully deployed.

Thus with the above embodiment, the auxiliary light projection apparatus 21 projects (as auxiliary light) light that is within a predetermined range of wavelengths into a predetermined region of the vehicle interior, such as a region including the front passenger seat 3, and the digital camera 11a thereby captures a photographic image of that region, with light that is within at least a part of the visible range of wavelengths having been eliminated when obtaining the image. It is thereby possible to prevent adverse effects upon the photographed image due to extraneous light from sunlight, vehicle headlamps, street lights, etc., which is within the visible range of wavelengths. Hence, images having a stable level of brightness can be obtained, so that by applying image processing to these images, the air bag deployment control apparatus 41 can accurately detect the condition (i.e., presence/absence, posture, adult/child classification) of an occupant of a vehicle seat. Based on the detection results obtained by the image processing apparatus 31, the air bag deployment control apparatus 41 can appropriately control deployment of the air bag corresponding to that occupant.

Specifically, the auxiliary light projection apparatus 21 projects auxiliary light within a predetermined range of wavelengths that includes at least part of the near infra-red range, while the digital camera 11a of the camera apparatus 11 has a spectral sensitivity which covers that part of the near infra-red range, and is provided with an optical bandpass filter which blocks light that is within a part of the visible range and passes light that is within at least part of the near infra-red range. Hence, an image can be photographed by the digital camera 11a utilizing only reflected infra-red light from a region which is illuminated by the auxiliary light projection apparatus 21, with the effects of extraneous light that is within the visible range being substantially entirely prevented from affecting the image. Hence, clear images can be obtained by the digital camera 11a. Since the auxiliary light is projected by the auxiliary light projection apparatus 21 irrespective of the ambient illumination conditions, i.e., during both night and daytime driving, clear images can be obtained by the digital camera 11a under all conditions.

Furthermore the location selected for the camera apparatus 11 ensures that an image of the occupant of a specific vehicle seat can be captured, with all other occupants of the vehicle excluded from the range of the image. Hence, complications of the image processing, such as a need to discriminate between the heads of various vehicle occupants, can be avoided. As a further result of the location adopted for the camera apparatus 11, it can be ensured that the head of the desired occupant (i.e., the part of the occupant which is most important for the purposes of the system) will appear in the captured image, so that the presence/absence of the occupant, the type of occupant (adult or child), etc., can be reliably judged.

Moreover due to the auxiliary light projection apparatus 21 also being mounted in a similar location (at approximately the center of the front part of the ceiling in the vehicle interior), the auxiliary light can be effectively projected into a region which is to appear in the obtained image.

In addition, due to the fact that with the above embodiment the predetermined region of the vehicle interior which is captured in the image includes the exit aperture of an air bag corresponding to a vehicle seat which is situated within that predetermined region, the system can judge whether the head of an occupant is in a dangerous location which is close to that air bag exit aperture. Appropriate control of deployment of that air bag can thereby be applied, as described above, so that increased safety of air bag deployment can be achieved.

A further advantage of the location selected for the camera apparatus 11 with the above embodiment is as follows. With such a location, as mentioned hereinabove, it becomes possible to relate positions within the image to corresponding positions along the longitudinal direction of the vehicle, i.e., so that distances between objects in the image can be used to estimate the actual distance between these objects, by applying an appropriate correction factor. Specifically, the distance between the head of an occupant (e.g., the front passenger) and the corresponding air bag exit aperture can be derived, based on an image which is obtained for that occupant. This function of deriving the distance between the head of an occupant and the corresponding air bag exit aperture is achieved by using only a single camera, so that it can be achieved with low manufacturing cost. Moreover, since complex processing is not required for deriving that distance, a high speed of response can be achieved.

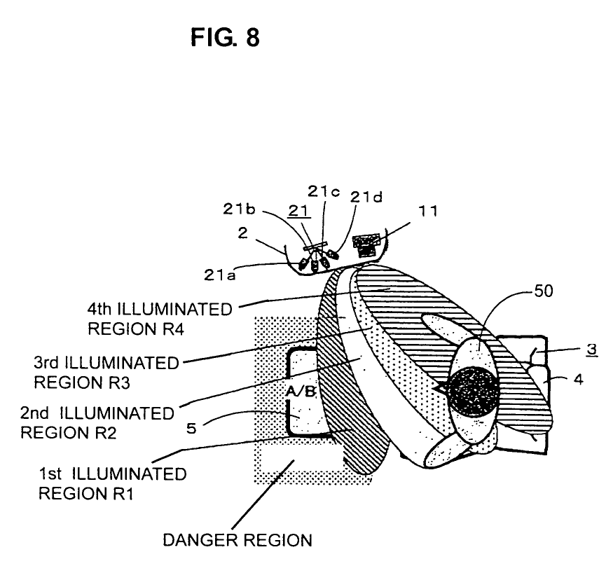

A second embodiment will be described in the following, referring to FIGS. 8 to 10. The overall configuration and operation of this embodiment is similar to that of the first embodiment, but differs with respect to the following. With the first embodiment described above, all of the four LEDs 21a˜21d emit infra-red light simultaneously, during each exposure interval of the digital camera 11a. However with the second embodiment, the four infra-red LEDs 21a˜21d emit infra-red light in succession during four respective emission intervals within each exposure interval of the digital camera 11a. In addition, with the second embodiment, light emission from each of the four infra-red LEDs 21a˜21d is highly directional, and their respective installation positions are adjusted such that they project infra-red light into respectively different parts of the aforementioned predetermined region within the vehicle interior which is to be captured in an image.

Specifically, referring to FIG. 8, these installation positions are adjusted such that the infra-red LED 21a projects its light into a first illuminated region R1 which contains the air bag exit aperture 5 corresponding to the front passenger seat, the infra-red LED 21b projects its light into a second illuminated region R2 which contains the seat cushion portion of the front passenger seat 3, the infra-red LED 21c projects its light into a third illuminated region R2 which contains the back rest portion of the front passenger seat 3, the infra-red LED 21d projects its light into a fourth illuminated region R3 which contains the head rest 4 of the front passenger seat 3.

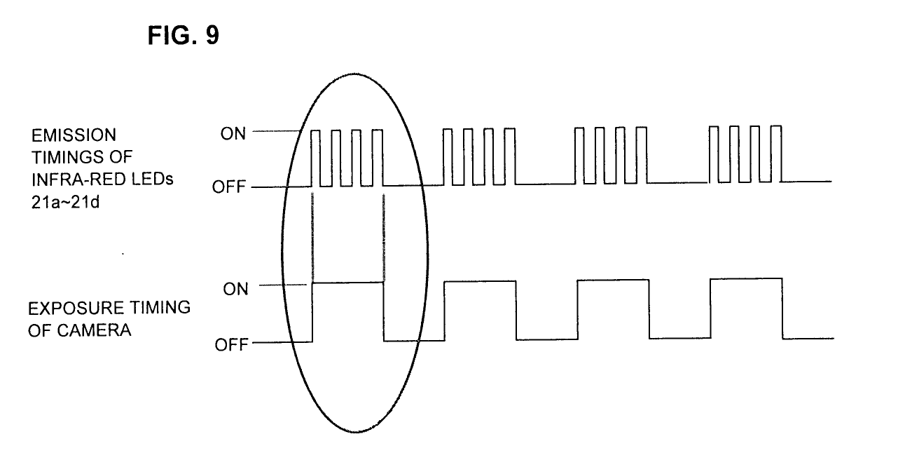

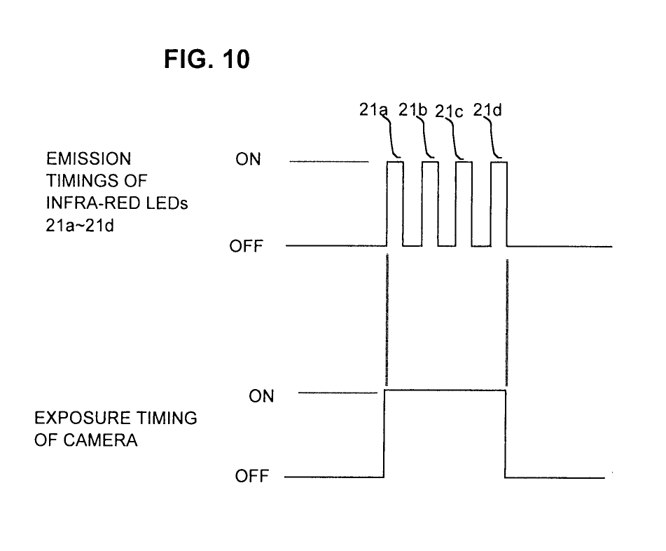

FIGS. 9 and 10 are timing diagrams for illustrating the manner in which the four LEDs 21a˜21d successively emit infra-red light during respective emission intervals within each exposure interval of the digital camera 11a. FIG. 9 shows the timing relationship between these emission intervals and exposure intervals, for a plurality of successive exposure intervals. FIG. 10 is an expanded view of the portion surrounded by a broken-line outline in FIG. 9, showing the timing relationships within a single exposure interval. As shown, during each exposure interval, the four LEDs 21a˜21d successively emit infra-red light that is projected into the illuminated regions R1 to R4 respectively, in respective emission intervals. In that way, infra-red light is projected into the entirety of a region extending from the head rest 4 to the air bag exit aperture 5 during each exposure interval.

The emission intervals of the four LEDs 21a˜21d are thus shorter, with the second embodiment, than with the first embodiment. Hence, the power consumption of these LEDs can be reduced, while in addition the operating lifetime of the LEDs can be extended.

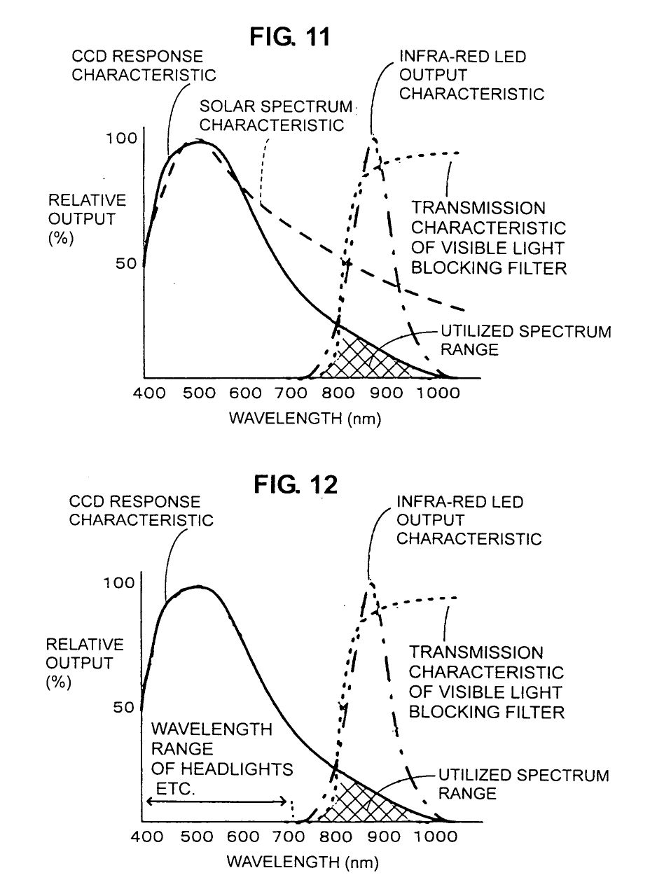

A third embodiment will be described in the following, referring to FIGS. 11 and 12. With this embodiment, the structure and operation can be substantially identical to those of the first or second embodiments described above. However the third embodiment differs in that in place of the optical bandpass filter 11b, a visible light cut-off filter is utilized, with that filter being designated in the following as 11d. Referring to the graphs of FIG. 11, while the vehicle is being operated in daytime, light which is within the visible range of the spectrum (i.e., which constitutes the major part of sunlight) is blocked from entering the digital camera 11a by the visible light cut-off filter 11d. The range of wavelengths which are actually utilized by the digital camera 11a thus becomes as indicated by the hatched-line region in FIG. 11. The effects of incident sunlight on the image obtained by the digital camera 11a can thereby be greatly reduced.

Furthermore referring to the graphs of FIG. 12, it can be understood that incident light from vehicle headlamps or from street lights is effectively blocked by the visible light cut-off filter 11d, so that the effects of such light on the image that is obtained by the digital camera 11a can be substantially eliminated.

As opposed to the optical bandpass filter 11b, the visible light cut-off filter 11d does not block those wavelengths that are longer than 1000 nm. However since the spectral sensitivity of the digital camera 11a does not extend to wavelengths above 1000 nm, similar effects to those of the first embodiment can be achieved.

It should be noted that the invention is not limited to the above embodiments, and that various modifications to these could be envisaged which fall within the scope claimed for the present invention. For example, other types of image sensor such as a CMOS (complementary metal-oxide semiconductor) type of image sensor could be used in the digital camera 11a instead of a CCD image sensor. It is only necessary that the spectral sensitivity of the image sensor be appropriate in relation to the near infra-red range of the spectrum.

Furthermore the above embodiments have been described for the case of capturing an image of the occupant of the front passenger seat. However it will be apparent that the invention can be similarly applied to detection of the condition of the vehicle driver, and of occupants of other seats in the vehicle.

Moreover with the above embodiments, the detection results obtained from an image are transmitted to an air bag deployment control apparatus 41. However these detection results could be similarly transmitted to a control apparatus of a vehicle occupant protection device, such as a seat belt pre-tensioner device, or a motor-driven device which repetitively rewinds a seat belt.

What is claimed is:

1. A vehicle occupant detection system comprising
an auxiliary light projection apparatus for projecting auxiliary light which is within a predetermined range of wavelengths into a predetermined region of a vehicle interior, said predetermined region including a vehicle seat,
a camera apparatus for photographing an image of said predetermined region, said image being expressed as digital data, with light that is within at least a part of the range of visible wavelengths being excluded when photographing said image, and
an image processing apparatus for applying image processing to said data expressing said image, to derive information indicative of a condition of an occupant of said vehicle seat.

2. A vehicle occupant detection system as claimed in claim 1, wherein said predetermined range of wavelengths of said auxiliary light includes at least a part of the near infra-red range, wherein said camera apparatus comprises a digital camera having a spectral sensitivity which extends to said part of the near infra-red range, and wherein said system comprises an optical filter disposed in a path of incident light which enters said digital camera, with said optical filter adapted to pass light that is within at least a part of said near infra-red range and to block light that is within a part of the range of visible wavelengths.

3. A vehicle occupant detection system as claimed in claim 1, wherein said auxiliary light projection apparatus projects said auxiliary light irrespective of a level of brightness within said vehicle interior.

4. A vehicle occupant detection system as claimed in claim 1, wherein said auxiliary light emitted from said auxiliary light projection apparatus is set at an emission output level such that said image photographed by said camera apparatus is not affected by reflections of said auxiliary light from glass surfaces of said vehicle interior, including surfaces of a windshield and side windows of said vehicle.

5. A vehicle occupant detection system as claimed in claim 1, wherein said auxiliary light projection apparatus comprises a plurality of light sources which project auxiliary light into respectively different regions of said vehicle interior, and wherein said light sources are successively activated in respective light emission intervals during an exposure interval of said camera apparatus.

6. A vehicle occupant detection system as claimed in claim 1, wherein said camera apparatus is mounted on a front part of a ceiling of said vehicle interior at a location which is substantially midway between left and right sides of said vehicle interior.

7. A vehicle occupant detection system as claimed in claim 1, wherein said auxiliary light projection apparatus is mounted on a front part of a ceiling of said vehicle interior at a location which is substantially midway between left and right sides of said vehicle interior.

8. A vehicle occupant detection system as claimed in claim 1, wherein said information derived by said image processing apparatus is indicative of a position of a head of said occupant of said vehicle seat.

9. A vehicle occupant detection system as claimed in claim 1, wherein said information derived by said image processing apparatus is indicative of a size of a head of said occupant of said vehicle seat

10. A vehicle occupant detection system as claimed in claim 1, wherein said predetermined region within said vehicle interior includes a position close to an exit aperture of an air bag corresponding to said vehicle seat.

11. A vehicle occupant detection system as claimed in claim 10, wherein said predetermined region includes a position close to a head rest portion of said vehicle seat.

12. A vehicle occupant detection system as claimed in claim 11, wherein said information derived by said image processing apparatus is indicative of a distance between a head of said occupant of said vehicle seat and said air bag exit aperture

13. A vehicle occupant detection system as claimed in claim 11, wherein said camera apparatus is mounted on said ceiling of said vehicle interior at a location which is intermediate between said air bag exit apparatus and said head rest portion of said vehicle seat, with respect to a longitudinal direction of said vehicle.
